(19) United States
(12) Patent Application Publication
(10) Pub. No.: US 2015/0039390 A1
(43) Pub. Date: Feb. 5, 2015

(54) MOBILE MARKETING AND TARGETING USING PURCHASE TRANSACTION DATA

(71) Applicant: MASTERCARD INTERNATIONAL INCORPORATED, Purchase, NY (US)

(72) Inventors: Po Hu, Norwalk, CT (US); Jean Pierre Gerard, Croton-on-Hudson, NY (US)

(73) Assignee: MASTERCARD INTERNATIONAL INCORPORATED, Purchase, NY (US)

(21) Appl. No.: 13/955,058

(22) Filed: Jul. 31, 2013

(51) Int. Cl. G06Q 30/02

(52) U.S. Cl. CPC G06Q 30/0202; G06Q 30/0255
USPC 705/7.31; 705/14.53

(57) ABSTRACT

A method for making a targeted offer by a telecommunication entity to an audience is provided. The method involves receiving from the telecommunication entity a first set of information including billing activities attributable to the telecommunication entity and payment activities attributable to the audience, by a financial transaction processing entity; retrieving by the financial transaction processing entity a second set of information including billing activities attributable to the financial transaction processing entity and purchasing and payment activities attributable to the audience; and generating one or more predictive behavioral models based at least in part on the first set and second set of information. The method also involves identifying activities and characteristics attributable to the audience based on the predictive behavioral models, and conveying those to the telecommunication entity. A system for making a targeted offer by a telecommunication entity to an audience is also provided.

### BACKGROUND OF THE DISCLOSURE

1. Field of the Disclosure

The present disclosure relates to a mobile marketing and targeting using purchase transaction data. More particularly, the present disclosure relates to a method and system to enable the telecommunication entity to make a targeted offer to the audience of potential acceptors.

2. Description of the Related Art

Marketing expenses are often one of the largest cost categories for an organization. Marketing difficulties in effectively capturing and reaching the correct population of consumers is an industry wide problem, regardless of goods or services offered. In an attempt to overcome these difficulties, entities often engage in various advertising techniques to a broad audience hoping to reach interested consumers. However, such broad advertising techniques are often ignored by consumers or fail to reach the intended audience.

Using relevant data, consumer activities and characteristics typically provide an effective form of targeted marketing by creating a shopping experience that is personalized and relevant to the consumer. However, targeted marketing systems are often limited to accessing only a specific set of data that provides less than a holistic view of a consumer's spending habits and preferences. For instance, a telecommunication company may have information regarding the products purchased from the telecommunication company by a particular consumer, but they lack the information on the type of products and services the same consumer purchases from other merchants.

Particularly, there are times that a specific merchant has access to information about a customer, based on the merchant's prior dealings with the customer, regarding a customer's personal circumstances that are not readily available to other merchants that have a business relationship with the first merchant. For instance, a financial institution may have access to certain customer data that indicates a spending behavior that is not apparent to one of the financial institution's retail partners. Because the retail partner is not aware of the customer's personal circumstances, it is not able to tailor its offer of products or services to suit the customer's present or imminent need and the customer may receive offers that are not relevant to her circumstances and miss the opportunity to purchase products or services that are more relevant.

Therefore, a need exists for a system that can provide a more effective form of targeted marketing by creating a shopping experience that is more personalized and relevant to the consumer. A more holistic view of a consumer's personal circumstances, including spending habits and preferences, is needed for effective targeted marketing. Further, a need exists for a system that can analyze a customer's personal circumstances and identify customer activities and circumstances that may represent an opportunity for a merchant to offer products or services to the customer that are specifically tailored to the customer's upcoming need or desire and communicate the offers to the customer.

### SUMMARY OF THE DISCLOSURE

The present disclosure relates to a method and system for making a targeted offer by a telecommunication entity to an audience of potential acceptors, specifically for the telecommunication entity associating or otherwise partnering with a financial transaction processing entity to identify ideal consumers for marketing purposes through the generation of predictive behavioral models that are based upon activities and characteristics attributable to the audience of potential acceptors, and to enable the telecommunication entity to make a targeted offer to the audience of potential acceptors.

The present disclosure also provides a method for making a targeted offer by a telecommunication entity to an audience of potential acceptors. The method comprises: receiving from the telecommunication entity, from one or more databases, a first set of information including billing activities attributable to the telecommunication entity and payment activities attributable to the audience of potential acceptors, by a financial transaction processing entity; retrieving by the financial transaction processing entity, from one or more databases, a second set of information including billing activities attributable to the financial transaction processing entity and purchasing and payment activities attributable to the audience of potential acceptors; generating one or more predictive behavioral models based at least in part on the first set of information and the second set of information; identifying activities and characteristics attributable to the audience of potential acceptors based on the one or more predictive behavioral models, the audience of potential acceptors having a propensity to carry out certain activities and to exhibit certain characteristics based on the one or more predictive behavioral models; and conveying to the telecommunication entity the activities and characteristics attributable to the audience of potential acceptors based on the one or more predictive behavioral models, to enable the telecommunication entity to make a targeted offer to the audience of potential acceptors.

The present disclosure further provides a system for making a targeted offer by a telecommunication entity to an audience of potential acceptors. The system comprises: one or more databases configured to store a first set of information including billing activities attributable to the telecommunication entity and payment activities attributable to the audience of potential acceptors; one or more databases configured to store a second set of information including billing activities attributable to a financial transaction processing entity and purchasing and payment activities attributable to the audience of potential acceptors; a processor configured to generate one or more predictive behavioral models based at least in part on the first set of information and the second set of information; identify activities and characteristics attributable to the audience of potential acceptors based on the one or more predictive behavioral models, the audience of potential acceptors having a propensity to carry out certain activities based on the one or more predictive behavioral models; and a device for conveying to the telecommunication entity the activities and characteristics attributable to the audience of potential acceptors based on the one or more predictive behavioral models, to enable the telecommunication entity to make a targeted offer to the audience of potential acceptors.

The present disclosure still further provides a method for generating one or more predictive behavioral models. The method comprises: retrieving, from one or more databases, information including activities and characteristics attributable to one or more payment card holders; analyzing the information to determine behavioral information of the one or more payment card holders; extracting information related to an intent of the one or more payment card holders from the behavioral information; and generating one or more predictive behavioral models based on the behavioral information and intent of the one or more payment card holders; the one or more payment card holders having a propensity to carry out certain activities based on the one or more predictive behavioral models.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 is a block diagram illustrating a high-level view of system architecture of a financial transaction processing system in accordance with exemplary embodiments.

FIG. 2 is a flow chart illustrating a method for generating predictive behavioral models in accordance with exemplary embodiments of this disclosure.

FIG. 3 is a block diagram illustrating illustrates a dataset for the storing, reviewing, and/or analyzing of information used in generating predictive behavioral models in accordance with exemplary embodiments.

FIG. 4 is a flow chart illustrating a method for making a targeted offer by a telecommunication company to an audience of potential acceptors in accordance with exemplary embodiments of this disclosure.

FIG. 5 is a flow chart illustrating a method for making a targeted offer by a telecommunication company partnering with a merchant to an audience of potential acceptors in accordance with exemplary embodiments of this disclosure.

FIG. 6 is a block diagram illustrating a method for making a targeted offer by a telecommunication company, optionally partnering with a merchant, to an audience of potential acceptors in accordance with exemplary embodiments of this disclosure.

A component or a feature that is common to more than one figure is indicated with the same reference number in each figure.

### DESCRIPTION OF THE EMBODIMENTS

Embodiments of the present disclosure can now be described more fully hereinafter with reference to the accompanying drawings, in which some, but not all, embodiments of the disclosure are shown. Indeed, the disclosure can be embodied in many different forms and should not be construed as limited to the embodiments set forth herein; rather, these embodiments are provided so that this disclosure may satisfy applicable legal requirements. Like numbers refer to like elements throughout.

As used herein, entities can include one or more persons, organizations, businesses, institutions and/or other entities, including but not limited to, financial institutions, and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium may be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the disclosure.

Thus, apparatus, systems, methods and computer program products are herein disclosed to generate predictive behavioral models, to identify, analyze, extract and correlate consumer activities and characteristics that represent an opportunity to target offer products or services to the consumer and for communicating the target offers to the consumer, and also an opportunity for predicting consumer behavior and intent. Embodiments of the present disclosure will leverage the information available to identify data that is indicative of a customer's activities and characteristics and to predict consumer behavior and intent based on those activities and characteristics. Such activities and characteristics can include, but are not limited to, spending behavior, age, gender, residence, graduation from college, a new job, marriage, the birth of a child, the purchase of a house, the purchase of a car, a member of the household starting college, etc. By identifying and analyzing consumer activities and characteristics, predictive behavioral models can be generated and one can offer products and services that are relevant to the consumer's needs.

In accordance with the present disclosure, information is matched on an anonymous basis by linking on purchase card transactions. For example, an identification number is associated with the first set of information that is conveyed from a telecommunication entity to a financial transaction processing entity to protect personally identifiable information (PII). This information is matched anonymously with financial transaction data by the financial transaction processing entity.

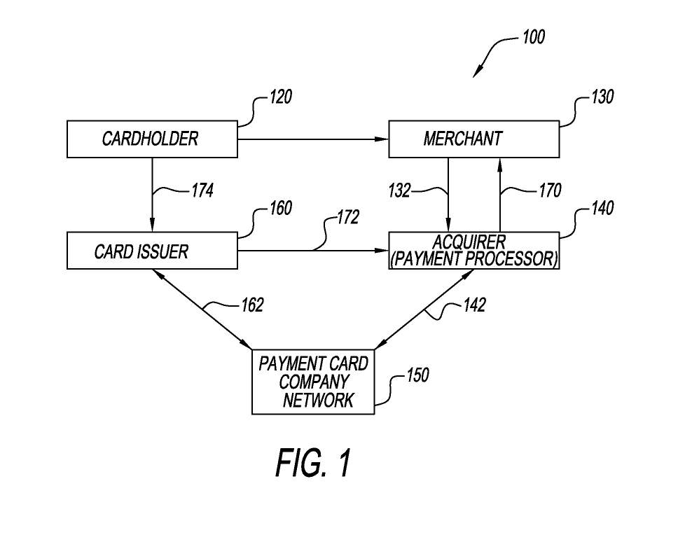

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

In accordance with the method of this disclosure, information that is stored in one or more databases may be retrieved (e.g., by a processor). The information can contain, for example, a first set of information including billing activities attributable to the telecommunication entity and payment activities attributable to the audience of potential acceptors (e.g., customers or subscribers of the telecommunication entity). Illustrative first set information can include, for example, financial (e.g., billing statements), demographic (e.g., age and gender), geographic (e.g., zip code and state or country of residence), and the like. Also, the information can contain, for example, a second set of information including billing activities attributable to the financial transaction processing entity (e.g., a payment card company) and purchasing and payment activities attributable to the audience of potential acceptors (e.g., payment card holders). Illustrative second set information can include, for example, financial (e.g., billing statements and payments), purchasing information, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or may be performed multiple times. In an exemplary embodiment, only information pertaining to a specific predictive behavioral model is retrieved from each of the databases.

In accordance with the method of this disclosure, one or more predictive behavioral models are generated based at least in part on the first set of information from the telecommunication entity and the second set of information from the financial transaction processing entity. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models may be based on specific criteria.

Predictive behavioral models are generated from the information obtained from each database. The information is analyzed, extracted and correlated by, for example, a financial transaction processing company (e.g., a payment card company), and can include financial account information, performing statistical analysis on financial account information, finding correlations between account information and consumer behaviors, predicting future consumer behaviors based on account information, relating information on a financial account with other financial accounts, or any other method of review suitable for the particular application of the data, which will be apparent to persons having skill in the relevant art.

Activities and characteristics attributable to the audience of potential acceptors based on the one or more predictive behavioral models are identified. The audience of potential acceptors has a propensity to carry out certain activities and to exhibit certain characteristics based on the one or more predictive behavioral models. The activities and characteristics attributable to the audience of potential acceptors and based on the one or more predictive behavioral models are conveyed by the financial transaction processing entity to the telecommunication entity. This enables a targeted offer to be made by the telecommunication entity to the audience of potential acceptors. The transmittal can be performed by any suitable method as will be apparent to persons having skill in the relevant art.

Predictive behavioral models can be defined based on geographical or demographical information, including but not limited to, age, gender, income, marital status, postal code, income, spending propensity, and familial status. In some embodiments, predictive behavioral models can be defined by a plurality of geographical and/or demographical categories. For example, a predictive behavioral model can be defined for any card holder with an income between $50,000 and $74,999, which card holder is between the ages of 20 and 29, and is single.

Predictive behavioral models can also be based on behavioral variables. For example, the financial transaction processing entity database can store information relating to financial transactions. The information can be used to determine an individual's likeliness to spend. An individual's likeliness to spend can be represented generally, or with respect to a particular industry (e.g., electronics), retailer (e.g., Macy's®), brand (e.g., Apple®), or any other criteria that can be suitable as will be apparent to persons having skill in the relevant art. An individual's behavior can also be based on additional factors, including but not limited to, time, location, and season. For example, a predictive behavioral model can be based on consumers who are likely to spend on electronics during the holiday season, or on consumers whose primary expenses are in a suburb, but are likely to spend on restaurants located in a major city. The factors and behaviors identified can vary widely and can be based on the application of the information.

Behavioral variables can also be applied to generated predictive behavioral models based on the attributes of the entities. For example, a predictive behavioral model of specific geographical and demographical attributes (e.g., single males in a particular postal code between the ages of 26-30 with an income between $100,000 and $149,999) can be analyzed for spending behaviors. Results of the analysis can be assigned to the predictive behavioral models. For example, the above predictive behavioral model is analyzed and reveals that the entities in the predictive behavioral model have a high spending propensity for electronics and are less likely to spend money during the month of February.

In an embodiment, the information retrieved from each of the databases can be analyzed to determine behavioral information of the audience of potential acceptors. Also, information related to an intent of the audience of potential acceptors can be extracted from the behavioral information. The predictive behavioral models can be based upon the behavioral information of the audience of potential acceptors and the intent of the audience of potential acceptors. The predictive behavioral models can be capable of predicting behavior and intent in the audience of potential acceptors.

Predictive behavioral models can be developed, for example, to examine spend behaviors and create spend associations. A spend association can be a set of spend behaviors that predict another spend behavior. For example, people that tend to purchase jewelry display the following spend behaviors: spend at Macy's®, travel on cruise ships, go to the movie theaters once a month, and so forth.

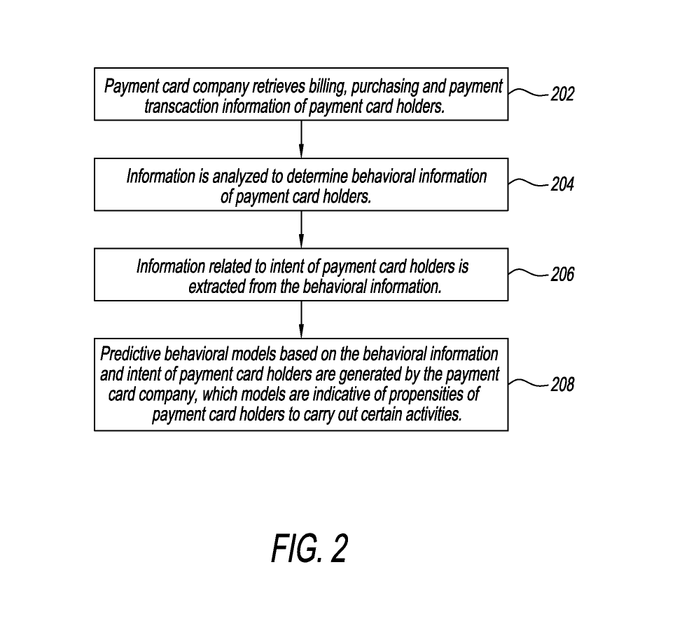

A method for generating one or more predictive behavioral models is an embodiment of this disclosure. Referring to FIG. 2, the method involves a payment card company (part of the payment card company network 150 in FIG. 1) retrieving, from one or more databases, information including activities and characteristics attributable to one or more payment card holders. The information 202 comprises payment card billing, purchasing and payment transactions, and optionally demographic and/or geographic information. The information is analyzed 204 to determine behavioral information of the one or more payment card holders. Information related to an intent 206 of the one or more payment card holders is extracted from the behavioral information. One or more predictive behavioral models are generated 208 based on the behavioral information and intent of the one or more payment card holders. The one or more payment card holders have a propensity to carry out certain activities based on the one or more predictive behavioral models.

In analyzing information to determine behavioral information, intent (audience) and other payment card member attributes are considered. Developing intent of audiences involves models that predict specific spend behavior in the future and desirable spend behaviors. Examples include as follows: likely to purchase at Macy's® in the next 2 weeks; likely to spend at least $100 in consumer electronics in the next 30 days; likely to purchase a car in the next 60 days; likely to be interested in golfing; likely to be up for a cell phone renewal in the next 60 days; likely to be a business traveler; and the like.

Predictive behavioral models can equate to purchase behaviors. There can be different degrees of predictive behavioral models with the ultimate behavior being a purchase. An example using Macy's® is as follows: an extreme behavior is a consumer purchasing something once a week at Macy's® and spending five times what the average customer spends; a medium behavior is a consumer purchasing something at Macy's® once a month and spending twice what the average customer spends; and a low behavior is a consumer purchasing something at Macy's® once a year and spending what the average customer spends.

There is the potential for numerous predictive behavioral models including, for example, industries (e.g., consumer electronics, QSR), categories (e.g., online spend, cross border), geography spend (e.g., spend in New York City, spend in London), geography residence (e.g., live in New York City, live in Seattle), day/time spend (e.g., weekday spend, lunch time spend), calendar spend (e.g., spend a lot around Christmas, spend a lot on flowers before Valentine's Day), top number of merchants, etc.

Other card holder attributes part of the information include, for example, geography (e.g., zip code, state or country), and demographics (e.g., age, gender, etc.).

The method further comprises conveying to a telecommunication entity the activities and characteristics attributable to the one or more payment card holders based on the one or more predictive behavioral models, to enable the telecommunication entity to make a targeted offer to the one or more payment card holders. The one or more predictive behavioral models are capable of predicting behavior and intent in the one or more payment card holders. The one or more payment card holders are people and/or businesses, the activities attributable to the one or more payment card holders are financial transactions associated with the one or more payment card holders, and the characteristics attributable to the one or more payment card holders are demographics and/or geographical characteristics of the one or more payment card holders.

A behavioral propensity score is used for conveying to the telecommunication entity the activities and characteristics attributable to the one or more payment card holders based on the one or more predictive behavioral models. The behavioral propensity score is indicative of a propensity to exhibit a certain behavior.

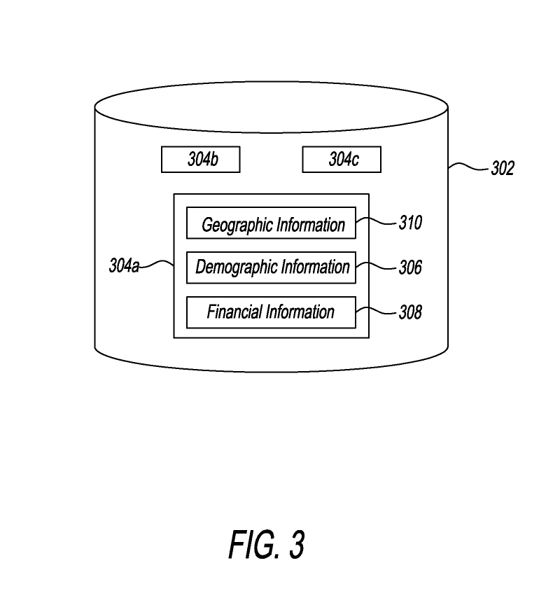

FIG. 3 illustrates an exemplary dataset 302 for the storing, reviewing, and/or analyzing of information used in generating predictive behavioral models. The dataset 302 can contain a plurality of entries (e.g., entries 304a, 304b, and 304c).

The demographic information 306 can include any demographic or other suitable information relevant to the particular application. For example, if a family restaurant is launching an advertising campaign and is requesting data of families with a spend propensity on restaurants, then the demographic information can include familial status, but not age. If a bar is launching an advertising campaign, then demographic information can include age, but not familial status. In some embodiments, the geographic information 310 can include geographic or other suitable information relevant to the particular application. Suitable types of information relevant for generating predictive behavioral models will be apparent to persons having skill in the relevant art. Likewise, the financial information 308 can include any financial information relevant to the particular application. For example, a dataset directed to advertisers in the food service industry can contain entries with financial information that includes a spend propensity for restaurants, but not a spend propensity for electronics.

Potential acceptor audiences can represent a wide variety of categories and attributes. In one embodiment, potential acceptor audiences can be created based on spending propensity of spending index in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), etc. Each industry can include a plurality of potential acceptor audiences (e.g., based on location, income groups, etc.).

Potential acceptor audiences can also be based on predictions of future behavior. For instance, a financial transaction processing company can analyze financial account information and behavioral information to predict future behavior of a potential acceptor.

Potential acceptor audiences can also be aligned with other similar potential acceptor audiences. Similar potential acceptor audiences can be determined by similarities in, for example, the audience parameters (e.g., nearby postal codes), or in the entities contained in the predictive behavioral models (e.g., a larger number of card holders common to both audiences). In one embodiment, the financial transaction processing company can create potential acceptor audiences based on received parameters, which can be aligned to audiences created by a third party on the same parameters yet include different entities or behaviors. The process and parameters for the alignment of potential acceptor audiences can be dependent on the application of the audiences, as will be apparent to persons having skill in the relevant art.

A financial transaction processing company can analyze the generated predictive behavioral models (e.g., by analyzing the stored data for each entity comprising the predictive behavioral model) for behavioral information (e.g., spend behaviors and propensities). In some embodiments, the behavioral information can be represented by a behavioral propensity score. Behavioral information can be assigned to each corresponding predictive behavioral model, or can be assigned to an audience of predictive behavioral models.

Predictive behavioral models or behavioral information can be updated or refreshed at a specified time (e.g., on a regular basis or upon request of a party). Updating predictive behavioral models can include updating the entities included in each predictive behavioral model with updated demographic data and/or updated financial data. Predictive behavioral models can also be updated by changing the attributes that define each predictive behavioral model, and generating a different set of behaviors. The process for updating behavioral information can depend on the circumstances regarding the need for the information itself

Although the above methods and processes are disclosed primarily with reference to financial data and spending behaviors, it will be apparent to persons having skill in the relevant art that the predictive behavioral models can be beneficial in a variety of other applications. Predictive behavioral models can be useful in the evaluation of consumer data that may need to be protected.

For instance, predictive behavioral models can have useful applications in measuring the effectiveness of advertising or other consumer campaigns. A party can desire to discover the effectiveness of a particular advertising campaign in reaching a specific set of consumers.

For example, a consumer electronics store may want to know the effectiveness of an advertising campaign initiated by the store and directed towards male consumers of a specific age and income group. The store can provide the financial transaction processing company with the demographic (e.g., demographical and geographical) data corresponding to the market. The financial transaction processing company can identify predictive behavioral models with corresponding demographic data and summarize relevant spend behaviors for the identified predictive behavioral models. Summary of the relevant spend behaviors (e.g., showing an increase or decrease in spending at the consumer electronic store) for each predictive behavioral model (e.g., including the predictive behavioral models of ideal consumers) can be provided to the consumer electronics store.

Predictive behavioral model data can also be combined or matched with other sources of data. For example, other transaction processing agencies, advertising firms, advertising networks, publishers, etc. can provide information on consumer groupings of their own. The financial transaction processing company can link or match the received consumer groupings, such as by matching groupings to generated predictive behavioral models based on geographical or demographical data.

Systems and methods disclosed herein can also have applications to the mobile communication device industry. For example, it may be common practice that mobile communication carriers provide mobile communication devices and services to consumers on a renewable contract for a specified time period (e.g., two years). The financial transaction processing company can be able to analyze spending behaviors for financial accounts to generate a predictive behavioral model or audience of individuals who may be nearing a renewal term on a contract with a mobile communication carrier (e.g., by identifying when a mobile communication device was purchased or two years of recurring payments to a mobile communication carrier). The audience can be provided to a mobile carrier as an ideal consumer base representing consumers in a position to change mobile communication carriers or take advantage of new contract offers. As another example, business travelers can be identified as a result of spending behaviors (e.g., weekday spending, a plurality of hotel, restaurant, and airline transactions, etc.) for generation of a corresponding audience of behaviors. Other beneficial applications of the systems and methods disclosed herein will be apparent to persons having skill in the relevant art(s).

Methods for the creation of predictive behavioral models and audiences can also be beneficial in the healthcare industry. For example, in hospitals, pharmaceutical companies, and insurance companies are all highly regulated. The creation of predictive behavioral models and analysis of behavioral information can greatly benefit these entities. An insurance company can have a database of all of its customers, including demographic data and other health-related data. The insurance company can use a linking environment to combine the demographic and health data with relevant data provided by a hospital. Relevant data includes, but is not limited to, prescription information, and illness information. The insurance company can combine the information and generate predictive behavioral models based on the demographic data health-related data, which can be analyzed to obtain potential health issues for entities in each predictive behavioral model or other useful information.

A pharmaceutical company can have demographical data on potential customer, and provide the geographical data to the insurance company. The insurance company can match each potential customer to a predictive behavioral model, and apply analyzed information, such as potential health issues for entities of that predictive behavioral model, to the potential customer.

Predictive behavioral models can also be useful in political campaign financing. Predictive behavioral models can also be beneficial in the profiling of potential consumers for the purposes of offering a payment card (e.g., a credit card). Predictive behavioral models can be used to identify consumer needs based on demographics and behavioral information in a much more efficient, more accurate fashion.

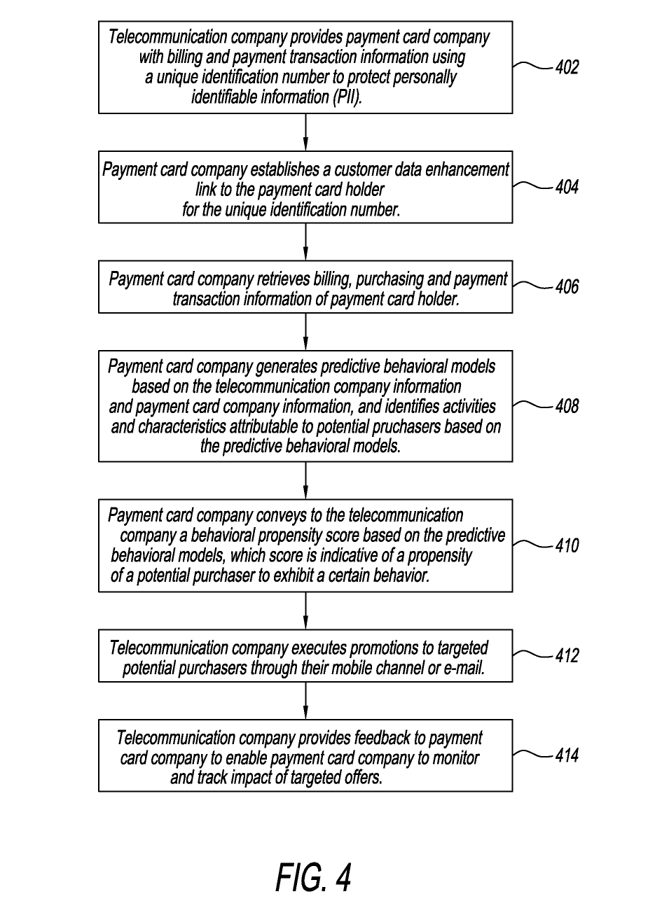

FIG. 4 illustrates an exemplary method for making a targeted offer by a telecommunication entity to an audience of potential acceptors. In step 402, a telecommunication company retrieves, from one or more databases (e.g., financial, demographic, geographic) a first set of information including billing activities attributable to the telecommunication entity and payment activities attributable to the audience of potential acceptors. The first set of information is conveyed to a financial transaction processing entity (e.g., the financial transaction processing entity that is part of the payment card company network 150 of FIG. 1). A unique identification number is used to protect any personally identifiable information (PII).

At 404, the payment card company establishes a customer data enhancement link to the payment card holder for the unique identification number. In step 406, the payment card company retrieves, from one or more databases (e.g., financial, demographic, geographic) a second set of information including activities attributable to an audience of potential acceptors. The information can include billing, purchasing and payment transaction information of a payment card holder.

The payment card company analyzes the first set of information and second set of information to determine behavioral information of the audience of potential acceptors. The payment card company extracts information related to intent of the audience of potential acceptors from the behavioral information.

In step 408, based on at least one of selected activities criteria and selected characteristics criteria from the first set of information and second set of information, including behavioral information and intent of the audience of potential acceptors, a plurality of predictive behavioral models are generated. The payment card company generates predictive behavioral models based on the telecommunication company information and payment card company information, and identifies activities and characteristics attributable to potential purchasers based on the predictive behavioral models. Activities and characteristics attributable to the audience of potential acceptors are identified based on the one or more predictive behavioral models. The audience of potential acceptors has a propensity to carry out certain activities and to exhibit certain characteristics based on the one or more predictive behavioral models.

The activities and characteristics attributable to the audience of potential acceptors based on the one or more predictive behavioral models are conveyed to the telecommunication entity at 410, to enable the telecommunication entity to make a targeted offer to the audience of potential acceptors. In an embodiment, the payment card company conveys to the telecommunication company at 410 a behavioral propensity score based on the predictive behavioral models. The score is indicative of a propensity of a potential purchaser to exhibit a certain behavior.

One example of a predictive behavioral model is as follows: live in the following zip codes AND like GAP® AND like Nordstrom® AND like movies AND like consumer electronics, etc. In 712, another example of a predictive behavioral model is as follows: between the ages of 25-35 AND like woman's apparel AND like Bloomingdales® AND like jewelry AND like family restaurants, etc.

In step 412, the predictive behavioral models are used to predict behavior and intent in an audience of potential acceptors (e.g., the above predictive behavioral model examples are used to predict individuals likely to purchase at Macy's® in the next week). The telecommunication company executes promotions to targeted potential purchasers through their mobile channel or e-mail.

In an embodiment, the telecommunication company provides feedback at 414 to the payment card company to enable the payment card company to monitor and track impact of targeted offers. This “closed loop” system allows an entity to track advertising campaigns, measure efficiency of the targeting, and make any improvements for the next round of campaigns.

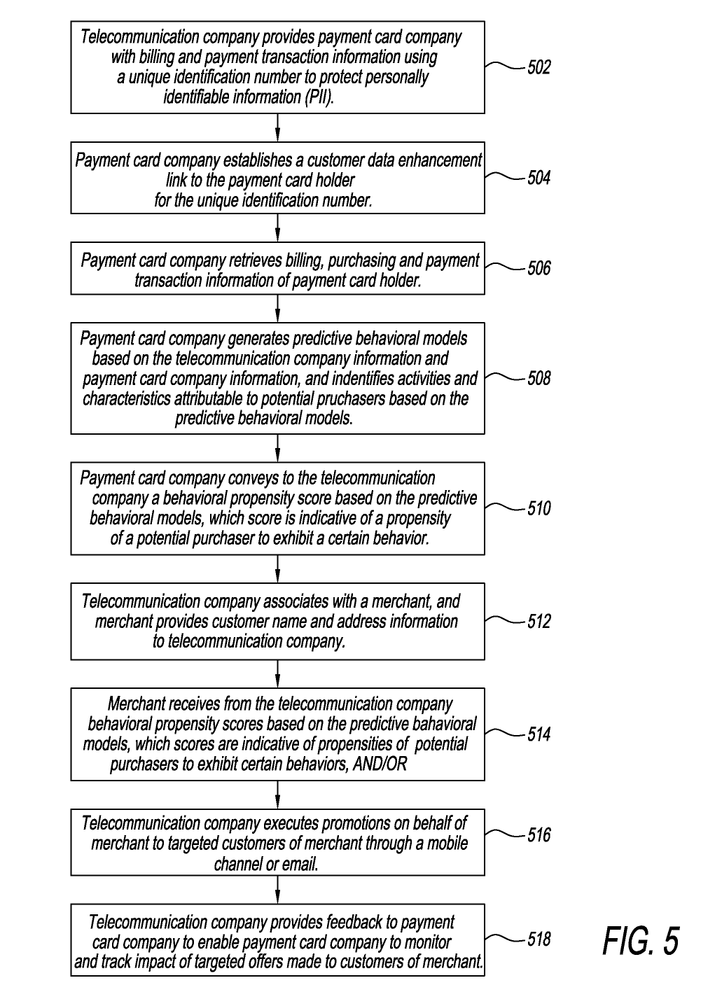

FIG. 5 illustrates another exemplary method for making a targeted offer to an audience of potential acceptors in which the telecommunication entity associates or otherwise partners with a merchant in making the targeted offer. In step 502, a telecommunication company retrieves, from one or more databases (e.g., financial, demographic, geographic) a first set of information including billing transaction information or activities attributable to the telecommunication entity and payment transaction information or activities attributable to the audience of potential acceptors. The first set of information is conveyed to a financial transaction processing entity (e.g., the financial transaction processing entity that is part of the payment card company network 150 of FIG. 1). A unique identification number is used to protect any personally identifiable information (PII).

At 504, the payment card company establishes a customer data enhancement link to the payment card holder for the unique identification number. At 506, the payment card company retrieves, from one or more databases (e.g., financial, demographic, geographic) a second set of information including activities attributable to an audience of potential acceptors. The information can include billing, purchasing and payment transaction information of a payment card holder.

The payment card company analyzes the first set of information and second set of information to determine behavioral information of the audience of potential acceptors. The payment card company extracts information related to intent of the audience of potential acceptors from the behavioral information.

In step 508, based on at least one of selected activities criteria and selected characteristics criteria from the first set of information and second set of information, including behavioral information and intent of the audience of potential acceptors, a plurality of predictive behavioral models are generated. The payment card company generates predictive behavioral models based on the telecommunication company information and payment card company information, and identifies activities and characteristics attributable to potential purchasers based on the predictive behavioral models. Activities and characteristics attributable to the audience of potential acceptors are identified based on the one or more predictive behavioral models. The audience of potential acceptors has a propensity to carry out certain activities and to exhibit certain characteristics based on the one or more predictive behavioral models.

At 510, the activities and characteristics attributable to the audience of potential acceptors based on the one or more predictive behavioral models are conveyed by the payment card company to the telecommunication entity. In an embodiment, the payment card company conveys to the telecommunication company a behavioral propensity score based on the predictive behavioral models. The score is indicative of a propensity of a potential purchaser to exhibit a certain behavior.

One example of a predictive behavioral model is as follows: live in the following zip codes AND like GAP® AND like Nordstrom® AND like movies AND like consumer electronics, etc. In 512, another example of a predictive behavioral model is as follows: between the ages of 25-35 AND like woman's apparel AND like Bloomingdales® AND like jewelry AND like family restaurants, etc.

The predictive behavioral models are used to predict behavior and intent in an audience of potential acceptors (e.g., the above predictive behavioral model examples are used to predict individuals likely to purchase at Macy's® in the next week).

At 512, the telecommunication company partners or selected others associate with a merchant, and the merchant provides customer name and address information to the telecommunication company. At 514, the merchant receives from the telecommunication company behavioral propensity scores based on the predictive behavioral models. The scores are indicative of propensities of potential purchasers to exhibit certain behaviors. Alternatively, at 516, the telecommunication company executes promotions on behalf of the merchant targeted at customers of merchant through a mobile channel or e-mail.

In an embodiment, the telecommunication company at 518 provides feedback to the payment card company to enable the payment card company to monitor and track impact of targeted offers made to customers of the merchant. This “closed loop” system allows an entity to track advertising campaigns, measure efficiency of the targeting, and make any improvements for the next round of campaigns.

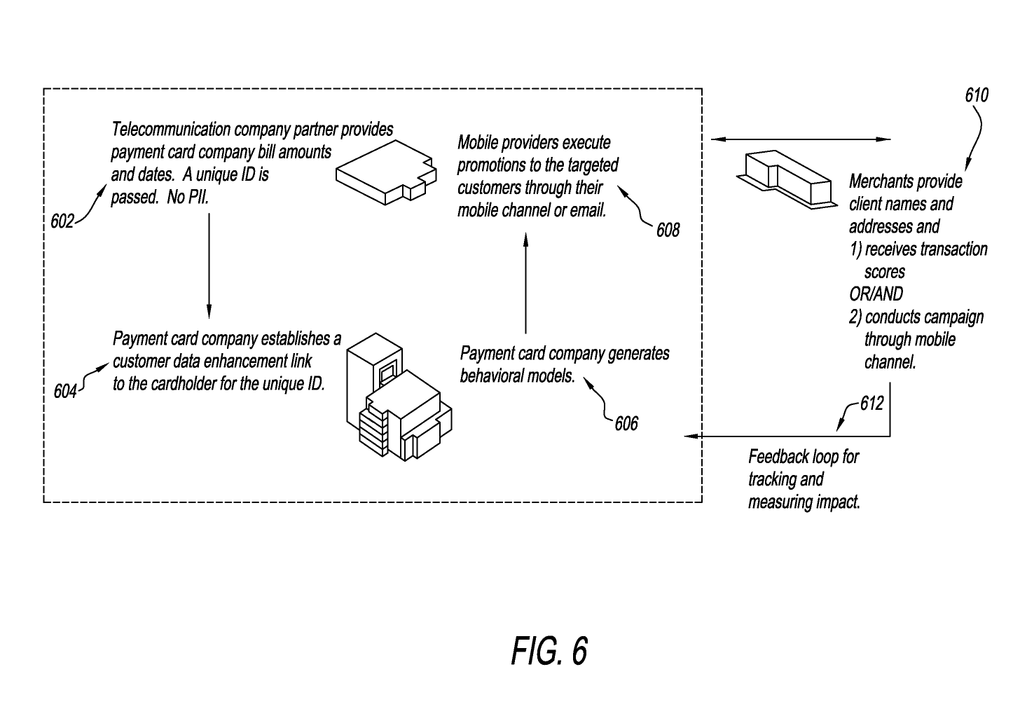

FIG. 6 illustrates another exemplary method for making a targeted offer to an audience of potential acceptors in which the telecommunication entity optionally associates or otherwise partners with a merchant in making the targeted offer. In step 602, a telecommunication company retrieves, from one or more databases (e.g., financial, demographic, geographic) a first set of information including billing activities attributable to the telecommunication entity and payment activities attributable to the audience of potential acceptors. The first set of information is conveyed to a financial transaction processing entity (e.g., the financial transaction processing entity that is part of the payment card company network 150 of FIG. 1). A unique identification number is used to protect any personally identifiable information (PII).

At 604, the payment card company establishes a customer data enhancement link to the payment card holder for the unique identification number. The payment card company retrieves, from one or more databases (e.g., financial, demographic, geographic) a second set of information including activities attributable to an audience of potential acceptors. The information can include billing, purchasing and payment transaction information of a payment card holder.

The payment card company analyzes the first set of information and second set of information to determine behavioral information of the audience of potential acceptors. The payment card company extracts information related to intent of the audience of potential acceptors from the behavioral information.

In step 606, based on at least one of selected activities criteria and selected characteristics criteria from the first set of information and second set of information, including behavioral information and intent of the audience of potential acceptors, a plurality of predictive behavioral models are generated. The payment card company generates predictive behavioral models based on the telecommunication company information and payment card company information, and identifies activities and characteristics attributable to potential purchasers based on the predictive behavioral models. Activities and characteristics attributable to the audience of potential acceptors are identified based on the one or more predictive behavioral models. The audience of potential acceptors has a propensity to carry out certain activities and to exhibit certain characteristics based on the one or more predictive behavioral models.

The activities and characteristics attributable to the audience of potential acceptors based on the one or more predictive behavioral models are conveyed by the payment card company to the telecommunication entity. In an embodiment, the payment card company conveys to the telecommunication company a behavioral propensity score based on the predictive behavioral models. The score is indicative of a propensity of a potential purchaser to exhibit a certain behavior.

The predictive behavioral models are used to predict behavior and intent in an audience of potential acceptors. At 608, the telecommunication company executes promotions to targeted potential purchasers through their mobile channel or e-mail.

At 610, the telecommunication company optionally partners or selected others associate with a merchant, and the merchant provides customer name and address information to the telecommunication company. The merchant receives from the telecommunication company behavioral propensity scores based on the predictive behavioral models. The scores are indicative of propensities of potential purchasers to exhibit certain behaviors. Alternatively, the telecommunication company executes promotions on behalf of the merchant targeted at customers of merchant through a mobile channel or e-mail.

In an embodiment, the telecommunication company at 612 provides feedback to the payment card company to enable the payment card company to monitor and track impact of targeted offers made to customers of the merchant. This “closed loop” system allows an entity to track advertising campaigns, measure efficiency of the targeting, and make any improvements for the next round of campaigns.

One or more algorithms can be employed to determine formulaic descriptions of the assembly of the payment card holder information including payment card billing, purchasing and payment transactions and optionally demographic and/or geographic information, using any of a variety of known mathematical techniques. These formulas in turn can be used to derive or generate one or more predictive behavioral models using any of a variety of available trend analysis algorithms.

Where methods described above indicate certain events occurring in certain orders, the ordering of certain events can be modified. Moreover, while a process depicted as a flowchart, block diagram, or the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

It should be understood that the present disclosure includes various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for making a targeted offer by a telecommunication entity to an audience of potential acceptors, said method comprising:
receiving from the telecommunication entity, from one or more databases, a first set of information including billing activities attributable to said telecommunication entity and payment activities attributable to said audience of potential acceptors, by a financial transaction processing entity;
retrieving by the financial transaction processing entity, from one or more databases, a second set of information including billing activities attributable to said financial transaction processing entity and purchasing and payment activities attributable to said audience of potential acceptors;
generating one or more predictive behavioral models based at least in part on the first set of information and the second set of information;
identifying activities and characteristics attributable to said audience of potential acceptors based on the one or more predictive behavioral models; and
conveying to the telecommunication entity said activities and characteristics attributable to said audience of potential acceptors based on the one or more predictive behavioral models, to enable the telecommunication entity to make a targeted offer to the audience of potential acceptors.

2. The method of claim 1, further comprising:
analyzing the first set of information and the second set of information to determine behavioral information of the audience of potential acceptors; and
extracting information related to an intent of the audience of potential acceptors from the behavioral information.

3. The method of claim 2, wherein the one or more predictive behavioral models are based upon the behavioral information of the audience of potential acceptors and the intent of the audience of potential acceptors.

4. The method of claim 1, wherein the audience of potential acceptors are people and/or businesses, the activities attributable to the audience of potential acceptors are financial transactions associated with the audience of potential acceptors, and the characteristics attributable to the audience of potential acceptors are demographics and/or geographical characteristics of the audience of potential acceptors.

5. The method of claim 1, wherein the first set of information comprises telecommunication billing and payment transactions and optionally demographic and/or geographic information.

6. The method of claim 1, wherein the second set of information comprises payment card billing, purchasing and payment transactions and optionally demographic and/or geographic information.

7. The method of claim 1, wherein the audience of potential acceptors comprise telecommunication entity subscribers and payment card holders.

8. The method of claim 1, wherein an identification number is associated with the first set of information that is received from the telecommunication entity by the financial transaction processing entity to protect personally identifiable information (PII).

9. The method of claim 1, wherein the telecommunication entity makes a targeted offer to the audience of potential acceptors by e-mails, text messages or phone calls.

10. The method of claim 1, further comprising:
tracking and measuring impact of the targeted offer based at least in part on purchasing and payment activities attributable to said audience of potential acceptors, after the targeted offer has been made.

11. The method of claim 1, further comprising:
associating said telecommunication entity with one or more merchant entities so as to enable a targeted offer to be made to customers of the one or more merchant entities.

12. A system for making a targeted offer by a telecommunication entity to an audience of potential acceptors, said system comprising:
one or more databases configured to store a first set of information including billing activities attributable to said telecommunication entity and payment activities attributable to said audience of potential acceptors;
one or more databases configured to store a second set of information including billing activities attributable to a financial transaction processing entity and purchasing and payment activities attributable to said audience of potential acceptors;
a processor configured to:
generate one or more predictive behavioral models based at least in part on the first set of information and the second set of information; and
identify activities and characteristics attributable to said audience of potential acceptors based on the one or more predictive behavioral models; and
a device for conveying to the telecommunication entity said activities and characteristics attributable to said audience of potential acceptors based on the one or more predictive behavioral models, to enable the telecommunication entity to make a targeted offer to the audience of potential acceptors.

13. The system of claim 12, wherein the processor is configured to:
analyze the first set of information and the second set of information to determine behavioral information of the audience of potential acceptors; and
extract information related to an intent of the audience of potential acceptors from the behavioral information.

14. The system of claim 13, wherein the one or more predictive behavioral models are based upon the behavioral information of the audience of potential acceptors and the intent of the audience of potential acceptors.

15. The system of claim 12, wherein the first set of information comprises telecommunication billing and payment transactions and optionally demographic and/or geographic information, and wherein the second set of information comprises payment card billing, purchasing and payment transactions and optionally demographic and/or geographic information.

16. The system of claim 12, wherein the processor is configured to:
track and measure impact of the targeted offer based at least in part on purchasing and payment activities attributable to said audience of potential acceptors, after the targeted offer has been made.

17. The system of claim 12, wherein the one or more predictive behavioral models provides a behavioral propensity score that is used for conveying to the telecommunication entity said activities and characteristics attributable to said audience of potential acceptors based on the one or more predictive behavioral models, and wherein the behavioral propensity score is indicative of a propensity to exhibit a certain behavior.

18. The system of claim 12, wherein the processor is configured to:
associate said telecommunication entity with one or more merchant entities so as to enable a targeted offer to be made to customers of the one or more merchant entities.

19. The system of claim 18, wherein the processor is configured to:
track and measure impact of the targeted offer based at least in part on purchasing and payment activities attributable to said audience of potential acceptors, after the targeted offer has been made.

20. The system of claim 17, wherein the behavioral propensity score is used for conveying to the one or more merchant entities said activities and characteristics attributable to said audience of potential acceptors based on the one or more predictive behavioral models, wherein the behavioral propensity score is indicative of a propensity to exhibit a certain behavior.

21. A method for generating one or more predictive behavioral models, said method comprising:
retrieving, from one or more databases, information including activities and characteristics attributable to one or more payment card holders;
analyzing the information to determine behavioral information of the one or more payment card holders;
extracting information related to an intent of the one or more payment card holders from the behavioral information; and
generating one or more predictive behavioral models based on the behavioral information and intent of the one or more payment card holders; the one or more payment card holders having a propensity to carry out certain activities based on the one or more predictive behavioral models.

22. The method of claim 21, further comprising:
conveying to a telecommunication entity the activities and characteristics attributable to said one or more payment card holders based on the one or more predictive behavioral models, to enable the telecommunication entity to make a targeted offer to the one or more payment card holders.

23. The method of claim 22, wherein the one or more predictive behavioral models are capable of predicting behavior and intent in the one or more payment card holders.
